(19) United States
(12) Patent Application Publication
(10) Pub. No.: US 2009/0280762 A1
(43) Pub. Date: Nov. 12, 2009

(54) HIGH-ORDER HARMONIC REJECTION MIXER USING CURRENT STEERING TECHNIQUE

(75) Inventors: Kyoung Seok PARK, Suwon (KR); Nam Heung KIM, Suwon (KR); Jeong Ki CHOI, Suwon (KR); Yo Sub MOON, Suwon (KR); Gyu Suck KIM, Seoul (KR); Seung Won SEO, Suwon (KR); Yoo Hwan KIM, Yongin (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/259,619

(22) Filed: Oct. 28, 2008

(30) Foreign Application Priority Data
May 9, 2008 (KR) 10-2008-0043637

(51) Int. Cl. H04B 1/16

(52) U.S. Cl. 455/205

(57) ABSTRACT

A mixer includes, an input current generation unit generating an input current; a first path circuit unit including n number of transistors having sources connected in common to an output node of the input current generation unit; and a second path circuit unit including n number of transistors having sources connected in common to the output node of the input current generation unit, and respectively corresponding to the n number of transistors included in the first path circuit unit. Local oscillator signals sequentially phase-shifted by 180°/n are individually input to gates of the n number of transistors included in the first path circuit unit, and local oscillator signals having opposite phases to the local oscillator signals input to the gates of the corresponding transistors included in the first path circuit unit are individually input to gates of the n number of transistors included in the second path circuit unit.

### CROSS-REFERENCE TO RELATED APPLICATIONS

This application claims the priority of Korean Patent Application No. 2008-0043637 filed on May 9, 2008, in the Korean Intellectual Property Office, the disclosure of which is incorporated herein by reference.

### BACKGROUND OF THE INVENTION

1. Field of the Invention

The present invention relates to mixers, and more particularly, to a high-order harmonic rejection filter using a current steering technique that can generate a sinusoidal wave oscillator signal from a plurality of square wave oscillator signals having different phases from each other.

2. Description of the Related Art

In general, a mixer is a circuit that functions as a multiplier of two input signals. A mixer is used to down-convert a radio frequency (RF) signal having high frequency to an intermediate frequency (IF) signal having low frequency or a baseband signal. The mixer is also used to up-convert the IF signal or the baseband signal to an RF signal.

FIG. 1 is a view illustrating the operation of a mixer according to the related art. Referring to FIG. 1, a mixer 10 generally uses a local oscillator (LO) signal that is generated by a voltage controlled oscillator (VOC) to up-convert or down-convert an input signal. The local oscillator signal may approximate a square waveform 14 but not a sinusoidal waveform. Unlike a sinusoidal waveform, a square waveform may contain harmonics at odd multiples of the fundamental frequency of the LO signal. Consequently, an output signal 16, generated by a mixer using a square waveform as an LO signal, contains harmonics at odd multiples (3LO, 5LO, and 7LO) of the fundamental frequency of the LO signal.

In order to prevent the generation of the harmonics, research has been conducted on a harmonic rejection filter that generates and uses a local oscillator signal that approximates a sinusoidal waveform by using square waves as local oscillator signals having different phases from each other.

However, according to the related art, the harmonic rejection filter mixes each of the LO signals having different phases, which are square waveforms, with an input signal, and adds all the results. This harmonic rejection filter requires one mixer circuit to which an input signal is applied at each of the different phases of the LO signals. Therefore, the number of components used to implement the entire harmonic rejection filter is increased. Further, the mixer circuits, which are individually provided at the phases of the LO signals, each include a circuit used to convert an input signal into a current, which causes a significant reduction in power efficiency.

### SUMMARY OF THE INVENTION

An aspect of the present invention provides a high-order harmonic rejection mixer using a current steering technique that receives an input signal to be subjected to frequency conversion through one input terminal, and at the same time, generates a sinusoidal wave local oscillator signal from square wave local oscillator signals having different phases so that the sinusoidal wave local oscillator signal can be used as an input signal.

According to an aspect of the present invention, there is provided a mixer converting a frequency of an input signal, the mixer including: an input current generation unit generating and outputting an input current corresponding to the input signal; a first path circuit unit including n number of transistors having sources connected in common to an output node of the input current generation unit; a second path circuit unit including n number of transistors having sources connected in common to the output node of the input current generation unit, and respectively corresponding to the n number of transistors included in the first path circuit unit; and a load unit connected to drains of the transistors included in the first path circuit unit at a connection node, and generating an output voltage at the connection node, wherein the transistors included in the first path circuit unit and the second path circuit unit and corresponding to each other are equal to each other, and the transistors included in the second path circuit unit have drains connected in common to a ground, and local oscillator signals sequentially phase-shifted by 180°/n are individually input to gates of the n number of transistors included in the first path circuit unit, and local oscillator signals having opposite phases to the local oscillator signals input to the gates of the corresponding transistors included in the first path circuit unit are individually input to gates of the n number of transistors included in the second path circuit unit.

The transconductance of each of the transistors included in the first path circuit unit may be determined so that a current, passing through the transistors of the first path circuit unit that are turned on or off according to the phase-shifted local oscillator signals, and then flowing through the load unit, follows a sinusoidal waveform.

According to another aspect of the present invention, there is provided a mixer converting a frequency of differential input signals including first and second input signals, the mixer including: an input current generation unit generating and outputting first and second input currents corresponding to the first and second input signals, respectively; a first path circuit unit including n number of transistors having sources connected in common to an output node of the first input current of the input current generation unit; a second path circuit unit including n number of transistors having sources connected in common to the output node of the first input current of the input current generation unit, and corresponding to the n number of transistors included in the first path circuit unit, respectively; a third path circuit unit including n number of transistors having sources connected in common to an output node of the second input current of the input current generation unit, and respectively corresponding to the n number of transistors included in the first path circuit unit; a fourth path circuit unit including n number of transistors having sources connected in common to the output node of the second input current of the input current generation unit, and respectively corresponding to the n number of transistors included in the first path circuit unit; a first load unit connected to drains of the transistors included in the first path circuit unit and the third path circuit unit at a connection node, and generating a first output voltage at the connection node; and a second load unit connected to drains of the transistors of the second path circuit unit and the fourth path circuit unit at a connection node, and generating a second output voltage at the connection node, wherein the transistors included in the first to fourth path circuit units and corresponding to each other are equal to each other, local oscillator signals sequentially phase-shifted by 180°/n are individually input to the gates of the n number of transistors included in the first path circuit unit, local oscillator signals having opposite phases to the local oscillator signals input to the gates of the corresponding transistors included in the first path circuit unit are individually input to the gates of the n number of transistors of each of the second and third path circuit units, and local oscillator signals equal to the local oscillator signals input to the gates of the corresponding transistors included in the first path circuit unit are individually input to the gates of the n number of transistors included in the fourth path circuit unit.

The transconductance of each of the transistors included in the first path circuit unit may be determined so that a current, passing through the transistors of the first path circuit unit and the transistors of the fourth path circuit unit that are turned on or off according to the phase-shifted local oscillator signals, and then flowing to the first load unit, follows a sinusoidal waveform.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the operation of a harmonic rejection filter according to the related art;

FIG. 2 is a circuit diagram illustrating a harmonic rejection mixer using a current steering technique according to an exemplary embodiment of the invention;

FIGS. 3a and 3b are views illustrating the operation of the embodiment shown in FIG. 2; and

FIG. 4 is a circuit diagram illustrating a harmonic rejection mixer using a current steering technique according to another exemplary embodiment of the invention.

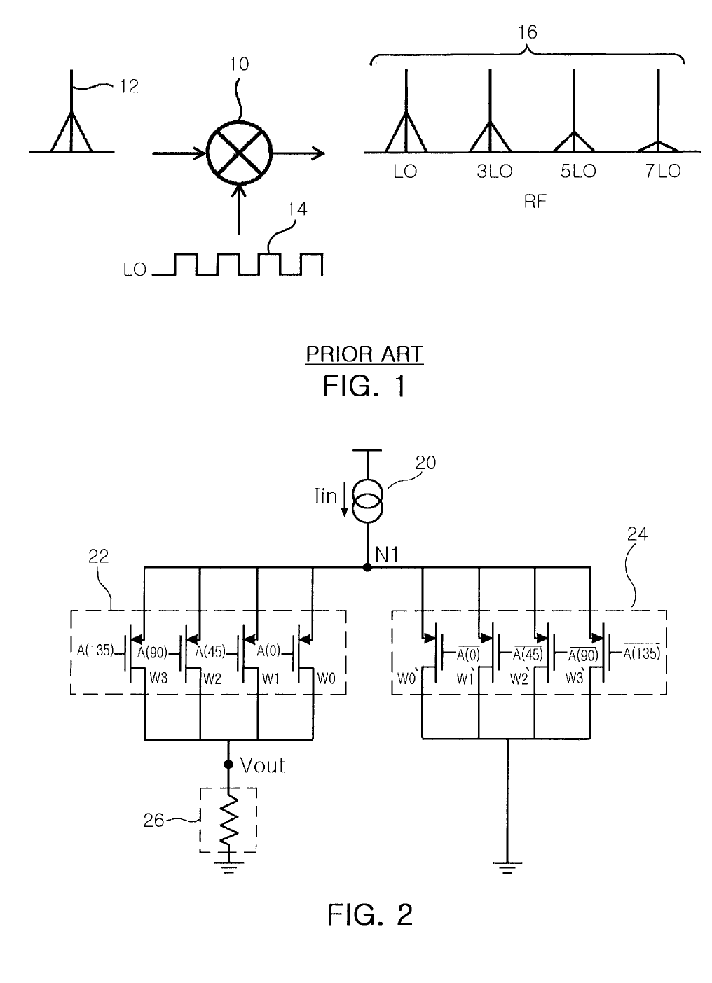

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

FIG. 2 is a circuit diagram illustrating a mixer using a current steering technique according to an exemplary embodiment of the invention.

Referring to FIG. 2, an input signal that will be subjected to frequency conversion is converted into a current by an input current generation unit 20. The current that is converted and output by the input current generation unit 20 is referred to as an input current Iin.

A first path circuit unit 22 and a second path circuit unit 24 are connected to an input node to which the input current Iin is input. In this embodiment, the first path circuit unit 22 may include four MOS transistors. That is, as shown in FIG. 2, the first path circuit unit 22 may include n number of MOS transistors W0 to W3 that have sources connected in common to an output node of the input current generation unit 20. In the same manner, the second path circuit unit 24 may include n number of MOS transistors W0′ to W3′ that correspond to the MOS transistors W0 to W3 included in the first path circuit unit 22, respectively. The MOS transistors that are included in the first and second path circuit units 22 and 24 and correspond to each other are equal to each other. Therefore, in FIG. 2, one set of MOS transistors included in the second path circuit unit 24 are denoted by reference characters W0′ to W3′ in which a mark (′) is added to the corresponding reference characters W0 to W3 of the other set of MOS transistors included in the first path circuit unit 22.

Drains of the MOS transistors W0 to W3 included in the first path circuit unit 22 are connected in common to a load 26 so as to generate a frequency-converted output voltage Vout. Further, drains of the MOS transistors W0′ to W3′ included in the second path circuit unit 24 are connected in common to a ground.

A local oscillator signal, generated by a separate local oscillator, is input to a gate of each of the MOS transistors W0 to W3 and W0′ and W3′ included in the first and second path circuit units 22 and 24. Since the local oscillator signal is a square wave signal, the local oscillator signal constantly changes between the high and low states. The local oscillator signal becomes a control signal used to determine whether each of the MOS transistors W0 to W3 and W0′ to W3′ is in on or off state. The oscillator signal that is input to the gate of each of the MOS transistors W0 to W3 and W0′ to W3′ is determined as follows.

When n number of MOS transistors are included in the first path circuit unit 22, a local oscillator signal, which is input to the gate of each of the MOS transistors included in the first path circuit unit 22, is sequentially phase-shifted by 180°/n. That is, local oscillator signals that are sequentially phase-shifted by 180°/n are input to the gates of the MOS transistors that are included in the first path circuit unit 22, so that the on-off timing of each of the MOS transistors included in the first path circuit unit 22 is controlled. For example, as shown in FIG. 2, when the first path circuit unit 22 includes the four MOS transistors W0 to W3, a local oscillator signals that is input to each of the gates of the MOS transistors W0 to W3 is sequentially phase-shifted by 180°/4(=45°). In FIG. 2, a local oscillator signal, which is input to the MOS transistor W0, is denoted by A(0), and a local oscillator signal, which is input to the MOS transistor W1, is denoted by A(45) since it means the local oscillator signal A(45) is obtained by shifting the phase of the local oscillator signal A(0) by 45°. In the same manner, a local oscillator signal, which is input to the MOS transistor W2, is denoted by A(90) since it means the local oscillator signal A(90) is obtained by shifting the phase of the local oscillator signal A(45) by 45°. Finally, a local oscillator signal, which is input to the MOS transistor W3, is denoted by A(135) since it means that the local oscillator signal A(135) is obtained by shifting the phase of the oscillator signal A(90) by 45°.

Signals having opposite phases to the phases of the local oscillator signals, which are input to the gates of the corresponding MOS transistors included in the first path circuit unit 22, are input to the gates of the MOS transistors included in the second path circuit unit 24. That is, a signal A̅(̅0̅)̅ has a phase opposite to the phase of the local oscillator signal A(0) that is input to the gate of the corresponding MOS transistor W0 included in the first path circuit unit 22. The signal A̅(̅0̅)̅ is input to the gate of the corresponding MOS transistor W0′ included in the second path circuit unit 24. In the same manner, a signal A̅(̅4̅5̅)̅ has a phase opposite to the phase of the local oscillator signal A(45) that is input to the gate of the MOS transistor W1, and the signal A̅(̅4̅5̅)̅ is input to the gate of the MOS transistor W1′ included in the second path circuit unit 24. A signal A̅(̅9̅0̅)̅ is input to the gate of the MOS transistor W2′, and a signal A̅(̅1̅3̅5̅)̅ is input to the gate of the MOS transistor W3′.

The MOS transistors corresponding to each other in the first and second path circuit units 22 and 24 can always maintain different states from each other by the local oscillator signals that are input to the gates of the MOS transistors W0 to W3 and W0′ to W3′. For example, when the transistor W0 of the first path circuit unit is turned on, the corresponding transistor W0′ of the second path circuit unit is turned off. In the same manner, the local oscillator signals that are input to the gates of the other transistors corresponding with each other have the same relationship as described above.

As such, the transistors corresponding to each other always have different states from each other. Therefore, four transistors that are included in the first or second path circuit unit are connected to an output node N1 for an input current at all times. That is, as for the entire transistors included in the first and second path circuit units, irrespective of the phases of the local oscillator signals that are input to the gates of the MOS transistors, four transistors included in one path circuit unit are always turned on. As a result, the impedance of the node N1 from which the input current is output keeps constant, and the current flowing through the first path circuit unit is controlled according to on-off states of switching and the transconductance of the MOS transistors in an on state. That is, a type of current steering technique can be applied to the embodiment of the invention.

In the mixer having the above-described circuit configuration according to the embodiment of the invention, the size of the MOS transistors W0 to W3 and W0′ to W3′ can be adjusted so that the MOS transistors have appropriate transconductance (gm) ratios with respect to each other. As a result, the sum of the phase-shifted local oscillator signals that are individually input to the gates of the n number of MOS transistors can follow an ideal sinusoidal waveform.

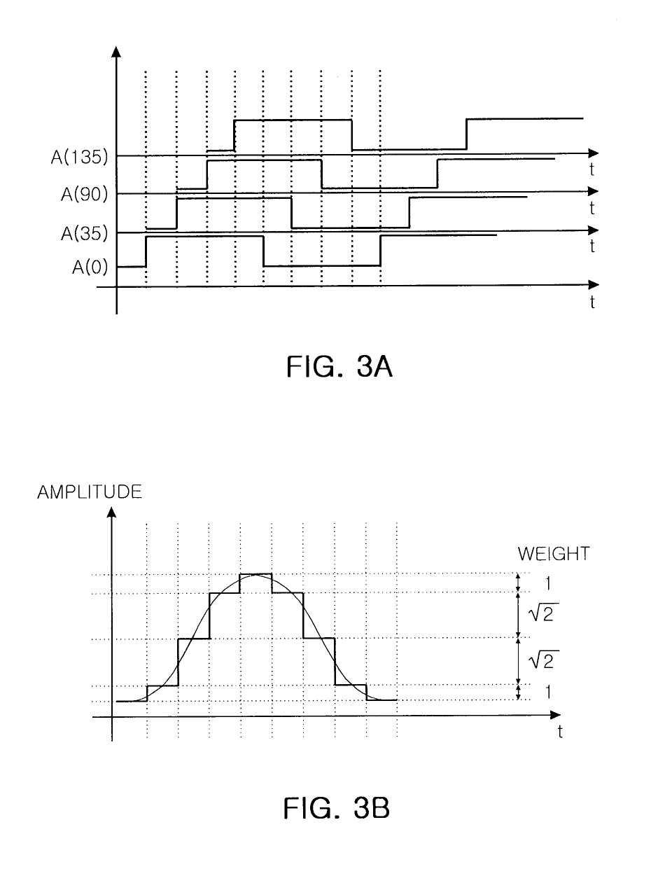

Hereinafter, the operation of the embodiment of the invention, shown in FIG. 2, will be described in more detail. To this end, in the embodiment, shown in FIG. 2, waveforms of the local oscillator signals that are input to the respective MOS transistors are shown in FIG. 3A, and a waveform of the sum of the corresponding local oscillator signals is shown in FIG. 3B.

The waveforms, shown in FIG. 3A, are individually input to the MOS transistors W0 to W3 of the first path circuit unit 22. The MOS transistors W0 to W3 have transconductances gm0 to gm3, respectively. The MOS transistor W0′ to W3′ included in the second path circuit unit 24 are the same as the corresponding MOS transistors W0 to W3 included in the first path circuit unit 22, respectively. Therefore, transistors corresponding to each other have the same transconductance.

First, at an interval t1-t2, the MOS transistor W0 of the first path circuit unit 22 is turned on, the other MOS transistors W1 to W3 are turned off, the MOS transistor W0′ of the second path circuit unit 24 is turned off, and the other transistors W1′ to W3′ are turned on. Therefore, a current that corresponds to the transconductance gm1 of the MOS transistor W0 from the transconductance gm0+gm1+gm2+gm3 of the entire MOS transistors in an ON-state included in the first and second path circuit units 22 and 24 flows through the first path circuit unit 22.

At an interval t2-t3, the MOS transistors W0 and W1 of the first path circuit unit 22 are turned on, and the other MOS transistors W2 and W3 are turned off. At the same time, the MOS transistors W0′ and W1′ of the second path circuit unit 24 that correspond to the MOS transistors W0 and W1 of the first path circuit unit 22, respectively, are turned off, and the other MOS transistors W2′ and W3′ are turned on. Therefore, a current that corresponds to the transconductance gm0+gm1 of the MOS transistors W0 and W1 from the transconductance gm0+gm1+gm2+gm3 of the entire MOS transistors in the ON-state in the first and second path circuit units 22 and 24 flows through the first path circuit unit 22.

At an interval t3-t4, the MOS transistors W0, W1, and W2 of the first path circuit unit 22 are turned on, and the other MOS transistor W3 is turned off. Further, the MOS transistors W0′, W1′, and W2′ of the second path circuit unit 24 that correspond to the MOS transistors W0, W1, and W2 of the first path circuit unit 22, respectively, are turned off, and the other MOS transistor W3′ is turned on. Therefore, a current that corresponds to the transconductance gm0+gm1+gm2 of the MOS transistors W0, W1, and W2 from the transconductance gm0+gm1+gm2+gm3 of the entire MOS transistors in the ON-state included in the first and second path circuit units 22 and 24 flows through the first path circuit unit 22.

At an interval t4-t5, all of the MOS transistors W0, W1, W2 and W3 of the first path circuit unit 22 are turned on, and all of the MOS transistors W0′, W1′, W2′, and W3′ of the second path circuit unit 24 are turned off. Therefore, the entire input current flows through the first path circuit unit 22.

At an interval t5-t6, the MOS transistors W1, W2, and W3 of the first path circuit unit 22 are turned on, and the other MOS transistor W0 is turned off. The MOS transistors W1′, W2′, and W3′ of the second path circuit unit 24 that correspond to the MOS transistors W1, W2, and W3 of the first path circuit unit 22, respectively, are turned off. At the same time, the other MOS transistor W0′ is turned on. Therefore, a current that corresponds to the transconductance gm1+gm2+gm3 of the MOS transistors W1, W2, and W3 from the transconductance gm0+gm1+gm2+gm3 of the entire MOS transistors included in the ON-state in the first and second path circuit units 22 and 24 flows through the first path circuit unit 22.

Then, at an interval t6-t7, the MOS transistors W2 and W3 of the first path circuit unit 22 are turned on, and the other MOS transistors W0 and W1 are turned off. At the same time, the MOS transistors W2′ and W3′ of the second path circuit unit 24 that correspond to the MOS transistors W2 and W3 of the first path circuit unit 22, respectively, are turned off, and the other MOS transistors W0′ and W1′ are turned on. Therefore, a current that corresponds to the transconductance gm2+gm3 of the MOS transistors W2 and W3 from the transconductance gm0+gm1+gm2+gm3 of the entire transistors in the ON-state included in the first and second path circuit units 22 and 24 flows through the first path circuit unit 22.

Finally, at an interval t7-t8, the MOS transistor W3 of the first path circuit unit 22 is turned on, and the other MOS transistors W0, W1, and W2 are turned off. Further, the MOS transistor W3′ of the second path circuit unit 24 that corresponds to the MOS transistor W3 of the first path circuit unit 22 is turned off, and the other MOS transistors W0′, W1′, and W2′ are turned on. Therefore, a current that corresponds to the transconductance gm3 of the MOS transistor W3 from the transconductance gm0+gm1+gm2+gm3 of the entire MOS transistors in the ON-state included in the first and second path circuit units 22 and 24 flows through the first path circuit unit 22.

As described above, the transconductance of the first path circuit unit 22 varies at each interval, and thus the current flow is controlled. Therefore, by appropriately controlling the transconductance of the MOS transistors W0 to W3, an effect can be obtained as if a sinusoidal waveform is applied to the input current. That is, the transconductance of the first path circuit unit 22 according to the phase-shifted local oscillator signals at each time intervals is shown in FIG. 3B. By controlling the transconductance of each of the MOS transistors, a waveform that follows an ideal sinusoidal S waveform can be formed. As shown in FIG. 3B, a change ratio decreases in a peak of the sinusoidal waveform, and a change ratio gradually increases between peaks. In consideration of this feature, the size of each of the MOS transistors W0 to W3 is controlled so that the MOS transistors W0 to W3 may have a transconductance ratio of 1:√2:√2:1.

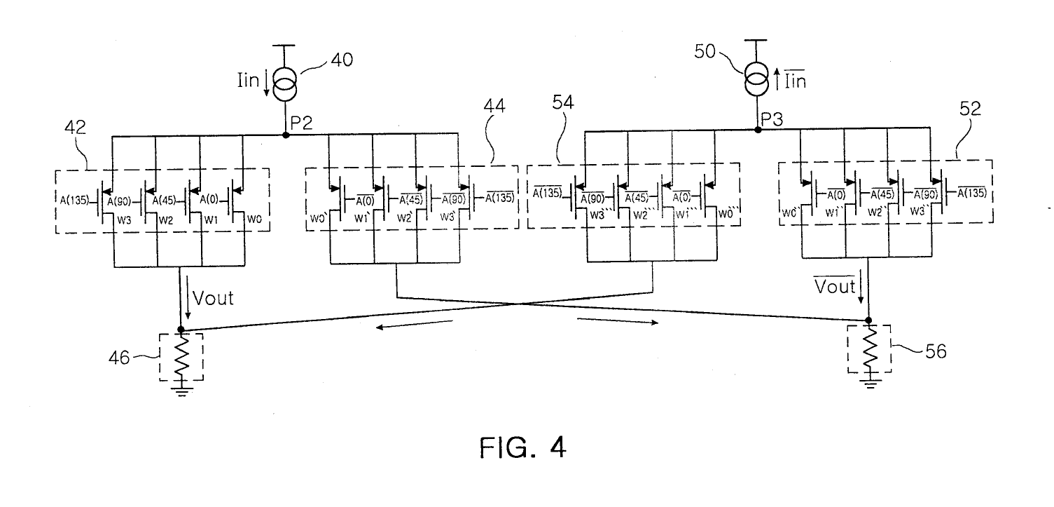

FIG. 4 is a circuit diagram illustrating a high-order harmonic rejection mixer using a current steering technique according to another exemplary embodiment of the invention. In FIG. 4, two mixers according to the embodiment of the invention, shown in FIG. 2, are coupled into one mixer. The mixer according to this embodiment can provide differential outputs in response to differential input signals. That is, the mixer according to the embodiment, shown in FIG. 2, has a circuit configuration in which an output is generated through one path between two paths through which an input current is divided and flows, and the current flows to the ground through the other path. On the other hand, the mixer according to this embodiment, shown in FIG. 4, uses the current, which flows to the ground in a case of the mixer according to the embodiment, shown in FIG. 2, in order to generate an output of a signal having different polarity between differential signals.

Specifically, the high-order harmonic rejection mixer according to this embodiment, shown in FIG. 4, includes input current generation units 40 and 50, first and second path circuit units 42 and 44, third and fourth path circuit units 52 and 54, a first load unit 46, and a second load unit 56. The input current generation units 40 and 50 generate first and second input currents Iin, I̅i̅n̅ that correspond to differential input signals that include first and second input signals, respectively. The first and second path circuit units 42 and 44 are used to apply a current steering technique to the first input current. The third and fourth path circuit units 52 and 54 are used to apply a current steering technique to the second input current. The first load unit 46 generates a first output voltage Vout. The second load unit 56 generates a second output voltage V̅o̅u̅t̅. The first output voltage and the second output voltage V̅o̅u̅t̅ form differential outputs.

The input current generation units 40 and 50 convert the differential input signals into currents, and output the currents. The differential input signals include the first input signal and the second input signal, respectively, which have opposite phases to each other. The input current generation units generate the first input current that corresponds to the first input signal, and the second input current that corresponds to the second input signal. Since the first input signal and the second input signal have opposite phases to each other, the first and second input currents Iin, I̅i̅n̅ have the same size and flow in opposite directions.

The first path circuit unit 42 may have n number of MOS transistors. The second path circuit unit 44 may have n number of MOS transistors that respectively correspond to the MOS transistors of the first path circuit unit 42. The MOS transistors corresponding to each other are equal to each other. In FIG. 4, the first path circuit unit 42 includes four MOS transistors W0 to W3, and the second path circuit unit 44 includes four MOS transistors W0′ to W3′. Further, the MOS transistors, included in the first path circuit unit 42 and the second path circuit unit 44, have sources that are connected in common to a node from which the first input current is output.

In the same manner, MOS transistors W0″ to W3″ included in the third path circuit unit 52 correspond to the MOS transistors W0 to W3 included in the first path circuit unit 42, respectively. MOS transistors corresponding to each other are equal to each other. MOS transistors W0′″ to W3′″ included in the fourth path circuit unit 54 correspond to the MOS transistors W0 to W3 included in the first path circuit unit 42, respectively. The MOS transistors corresponding to each other are the same as each other. That is, the first to fourth path circuit units 42, 44, 52, and 54 include the same MOS transistors as each other. In particular, the MOS transistors corresponding to each other are the same as each other. In FIG. 4, the MOS transistors corresponding to each other are denoted by the same reference characters but the number of marks varies.

The MOS transistors included in the first path circuit unit 42 have drains that are connected in common to the first load unit 46 that generates the first output voltage Vout that is one of the differential outputs. The MOS transistors that are included in the second path circuit unit 44 have drains that are connected in common to the second load unit 56 that generates the second output voltage V̅o̅u̅t̅ that is the other differential output. In the same manner, the MOS transistors included in the third path circuit unit 52 have drains that are connected in common to the second load unit 56 that generates the second output voltage V̅o̅u̅t̅. The MOS transistors included in the fourth path circuit unit 54 have drains that are connected in common to the first load unit 46 that generates the first output voltage Vout.

As described in the embodiment of FIG. 2, local oscillator signals A(0), A(45), A(90), and A(135) that are sequentially phase-shifted by 180°/n are input to gates of the n number of transistors that are included in the first path circuit unit 42, and local oscillator signals A̅(̅0̅)̅, A̅(̅4̅5̅)̅, A̅(̅9̅0̅)̅, A̅(̅1̅3̅5̅)̅ having opposite phases to the local oscillator signals that are input to gates of the corresponding transistors included in the first path circuit unit 42 are input to gates of the transistors included in the second path circuit unit 44. In the same manner, local oscillator signals A(0), A(45), A(90), and A(135) that are the same as the local oscillator signals that are input to the gates of the corresponding transistors included in the first path circuit unit 42 are input to gates of the transistors included in the third path circuit unit 52. Local oscillator signals A̅(̅0̅)̅, A̅(̅4̅5̅)̅, A̅(̅9̅0̅)̅, A̅(̅1̅3̅5̅)̅ having opposite phases to the local oscillator signals that are input to the gates of the corresponding transistors of the first phase circuit unit 42, that is, the same local oscillator signals that are input to the gates of the MOS transistors included in the second path circuit unit 44 are input to gates of the transistors included in the fourth path circuit unit 54.

The embodiment of the invention, shown in FIG. 4, performs substantially the same operation as the embodiment of the invention, shown in FIG. 2. However, the current, which flows to the ground through the second path circuit unit in the embodiment, shown in FIG. 2, flows as the differential output having different polarity in the embodiment, shown in FIG. 4.

For example, at the interval t1-t2, shown in FIG. 3A, the MOS transistor W0 of the first path circuit unit 42 is turned on, and the MOS transistors W1′, W2′, and W3′ of the second path circuit unit 44 are turned on. In the same manner, the MOS transistor W0″ of the third path circuit unit 52 is turned on, and the MOS transistors W1′″, W2′″, and W3′″ of the second path circuit unit 44 are turned on. When the MOS transistors W0 to W3 have transconductances gm0 to gm3, respectively, a current flowing through the first load unit 46 and forming the output voltage Vout that is one of the differential output voltages has a multitude corresponding to a transconductance “gm0−gm1−gm2−gm3”. Here, in the current flowing through the first load unit 46, a transconductance “gm0” is provided by the MOS transistor W0 of the first path circuit unit 42. Since a current “−gm1−gm2−gm3” is provided by the MOS transistors W1′″, W2′″, and W3′″ of the fourth path circuit unit 54, a current corresponding to the transconductance “−gm1−gm2−gm3” by the MOS transistors flows in the opposite direction, and thus has a minus symbol. In the same manner, a current flowing through the second load unit 56 and forming the other differential output voltage V̅o̅u̅t̅ has a multitude corresponding to a transconductance “−gm0+gm1+gm2+gm3”. As such, the current flowing through the first load unit 46 and the current flowing through the second load unit 56 are fully differential outputs. The embodiment, shown in FIG. 4, can operate as a fully differential mixer. In the same manner, differential currents flow through the first and second load units 46 and 56 at different time intervals, which can be easily understood by a person skilled in the art from the above description. Thus, a description of the operation at other time intervals will be omitted.

Further, like the embodiment in FIG. 2, the embodiment, shown in FIG. 4, can appropriately control the transconductance of each of the MOS transistors so that current multitudes according to a phase difference between local oscillator signals at each time intervals can form a sinusoidal waveform.

In the embodiment, shown in FIG. 4, when the load units 46 and 56 are formed of capacitors, the invention can operate as a current sampler.

As set forth above, according to the exemplary embodiments of the invention, by using a current steering technique, one mixer circuit is not required at every phase of a local oscillator signal unlike a harmonic rejection filter according to the related art, and an effect produced when a desired sinusoidal waveform is used as a local oscillator signal can be obtained by simply controlling the size of MOS transistors. Further, a mixer is implemented by converting an input signal into an input current only once regardless of the number of phases of local oscillator signals.

While the present invention has been shown and described in connection with the exemplary embodiments, it will be apparent to those skilled in the art that modifications and variations can be made without departing from the spirit and scope of the invention as defined by the appended claims.

What is claimed is:

1. A mixer converting a frequency of an input signal, the mixer comprising:
an input current generation unit generating and outputting an input current corresponding to the input signal;
a first path circuit unit including n number of transistors having sources connected in common to an output node of the input current generation unit;
a second path circuit unit including n number of transistors having sources connected in common to the output node of the input current generation unit, and respectively corresponding to the n number of transistors included in the first path circuit unit; and
a load unit connected to drains of the transistors included in the first path circuit unit at a connection node, and generating an output voltage at the connection node,
wherein the transistors included in the first path circuit unit and the second path circuit unit and corresponding to each other are equal to each other, and the transistors included in the second path circuit unit have drains connected in common to a ground, and
local oscillator signals sequentially phase-shifted by 180°/n are individually input to gates of the n number of transistors included in the first path circuit unit, and local oscillator signals having opposite phases to the local oscillator signals input to the gates of the corresponding transistors included in the first path circuit unit are individually input to gates of the n number of transistors included in the second path circuit unit.

2. The mixer of claim 1, wherein the transconductance of each of the transistors included in the first path circuit unit is determined so that a current, passing through the transistors of the first path circuit unit that are turned on or off according to the phase-shifted local oscillator signals, and then flowing through the load unit, follows a sinusoidal waveform.

3. A mixer converting a frequency of differential input signals including first and second input signals, the mixer comprising:
an input current generation unit generating and outputting first and second input currents corresponding to the first and second input signals, respectively;
a first path circuit unit including n number of transistors having sources connected in common to an output node of the first input current of the input current generation unit;
a second path circuit unit including n number of transistors having sources connected in common to the output node of the first input current of the input current generation unit, and corresponding to the n number of transistors included in the first path circuit unit, respectively;
a third path circuit unit including n number of transistors having sources connected in common to an output node of the second input current of the input current generation unit, and respectively corresponding to the n number of transistors included in the first path circuit unit;
a fourth path circuit unit including n number of transistors having sources connected in common to the output node of the second input current of the input current generation unit, and respectively corresponding to the n number of transistors included in the first path circuit unit;
a first load unit connected to drains of the transistors included in the first path circuit unit and the third path circuit unit at a connection node, and generating a first output voltage at the connection node; and
a second load unit connected to drains of the transistors of the second path circuit unit and the fourth path circuit unit at a connection node, and generating a second output voltage at the connection node,
wherein the transistors included in the first to fourth path circuit units and corresponding to each other are equal to each other, local oscillator signals sequentially phase-shifted by 180°/n are individually input to the gates of the n number of transistors included in the first path circuit unit, local oscillator signals having opposite phases to the local oscillator signals input to the gates of the corresponding transistors included in the first path circuit unit are individually input to the gates of the n number of transistors of each of the second and third path circuit units, and local oscillator signals equal to the local oscillator signals input to the gates of the corresponding transistors included in the first path circuit unit are individually input to the gates of the n number of transistors included in the fourth path circuit unit.

4. The mixer of claim 3, wherein the transconductance of each of the transistors included in the first path circuit unit is determined so that a current, passing through the transistors of the first path circuit unit and the transistors of the fourth path circuit unit that are turned on or off according to the phase-shifted local oscillator signals, and then flowing to the first load unit, follows a sinusoidal waveform.
